(19) United States
(12) Patent Application Publication
(10) Pub. No.: US 2025/0388227 A1
(43) Pub. Date: Dec. 25, 2025

(54) DISPLAY CONTROL APPARATUS

(71) Applicant: TOYOTA JIDOSHA KABUSHIKI KAISHA, Toyota-shi (JP)

(72) Inventor: Takahiro KAWANO, Chofu-shi (JP)

(73) Assignee: TOYOTA JIDOSHA KABUSHIKI KAISHA, Toyota-shi (JP)

(21) Appl. No.: 19/214,373

(22) Filed: May 21, 2025

(30) Foreign Application Priority Data
Jun. 25, 2024 (JP) 2024-102076

(51) Int. Cl. B60W 50/14; B60W 60/00

(52) U.S. Cl. CPC B60W 50/14; B60W 60/0017; B60W 2050/146; B60W 2420/403

(57) ABSTRACT

A display control apparatus includes: an object recognition unit configured to recognize an object around a vehicle based on a detection result of an external sensor mounted on the vehicle; a display target specification unit configured to specify the object present within a predetermined distance threshold around the vehicle as a display target object; and a display control unit configured to display the display target object on a display unit. The display target specification unit sets the distance threshold when a predetermined vehicle position condition or a predetermined time condition related to a predetermined object for early display is satisfied to be greater than the distance threshold when the vehicle position condition and the time condition are not satisfied.

### CROSS-REFERENCE TO RELATED APPLICATION

This application is based upon and claims the benefit of priority from Japanese Patent Application No. 2024-102076, filed on Jun. 25, 2024, the entire contents of which are incorporated herein by reference.

### TECHNICAL FIELD

The present disclosure relates to a display control apparatus.

### BACKGROUND

Japanese Unexamined Patent Publication No. 2007-192681 discloses a driving assistance device that, when a building with a predetermined attribute (for example, an elementary or junior high school) is detected within a first predetermined area based on a position of a host vehicle, superimposes a second predetermined area (for example, a school zone) including the detected building as visual information on map information and presents the map information to a driver of the host vehicle.

There may be display control devices configured to display an image to an occupant of a vehicle so as to uniformly display objects coming within a predetermined distance threshold in a three-dimensional space around the vehicle based on detection results of an external sensor mounted on the vehicle. In such a configuration, even when an attempt to display a specific object earlier than other objects is made, the other objects are also uniformly displayed early under all conditions. Therefore, there is room for improvement.

### SUMMARY

An example display control apparatus including: an object recognition unit configured to recognize an object around a vehicle based on a detection result of an external sensor mounted on the vehicle; a display target specification unit configured to specify the object present within a predetermined distance threshold around the vehicle as a display target object; and a display control unit configured to display the display target object on a display unit. The display target specification unit sets the distance threshold when a predetermined vehicle position condition or a predetermined time condition related to a predetermined object for early display is satisfied to be greater than the distance threshold when the vehicle position condition and the time condition are not satisfied.

In the display control apparatus according to the example, the distance threshold when the vehicle position condition or the time condition is satisfied is greater than the distance threshold when the vehicle position condition and the time condition are not satisfied. Since objects including the object for early display are likely to be present within the increased distance threshold, the objects including the object for early display are likely to be specified earlier as the display target objects compared to when the distance threshold is not increased. Therefore, instead of, for example, displaying the objects uniformly early under all conditions, the object for early display requiring early attention can be displayed early on the display unit only when the vehicle position condition or the time condition is satisfied.

In some examples, the display target specification unit may set the distance threshold according to a type of the object and increase the distance threshold when the vehicle position condition or the time condition is satisfied for each type of the object.

In some examples, the object recognition unit may recognize an obstacle hindering a movement of the object around the vehicle based on the detection result of the external sensor, and the display target specification unit may not increase the distance threshold in a direction in which the obstacle is present, even if the vehicle position condition or the time condition is satisfied.

In some examples, the object for early display may be a child among pedestrians, and the vehicle position condition may be satisfied when a vehicle position of the vehicle is included in a school zone.

In some examples, the object for early display may be a child among pedestrians, and the time condition may be satisfied when a current time falls within a predetermined school commute time period.

According to some examples of the present disclosure, it is possible to early display the object for early display requiring early attention on the display unit.

### BRIEF DESCRIPTION OF THE DRAWINGS

FIG. 1 is a block diagram illustrating an example of a display control apparatus.

FIG. 2 is a view illustrating an example of setting of a distance threshold.

FIG. 3 is a view illustrating another example of the setting of the distance threshold.

FIG. 4 is a flowchart illustrating an example of an object display process.

FIG. 5 is a flowchart illustrating an example of a threshold setting process.

FIG. 6 is a view illustrating a modification example of the setting of the distance threshold shown in FIG. 3.

### DETAILED DESCRIPTION

Hereinafter, examples of the present disclosure will be described with reference to the drawings.

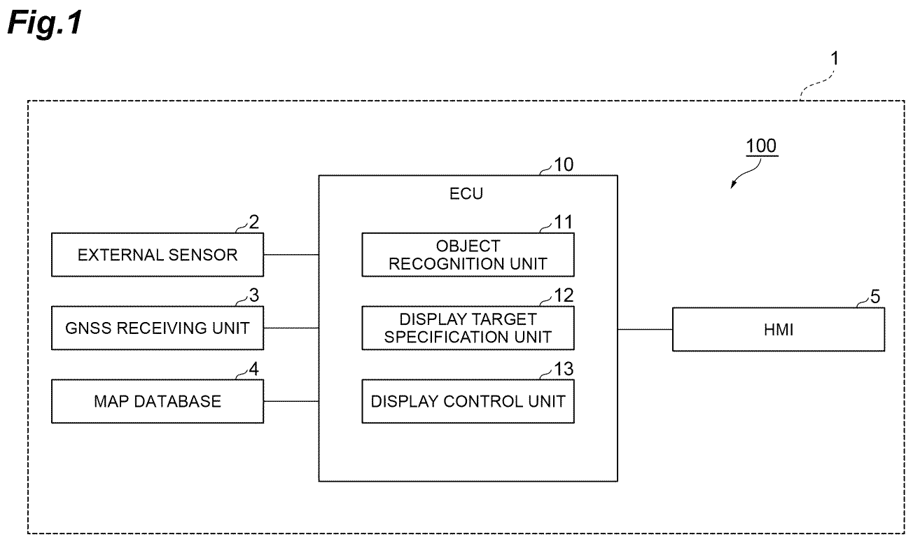

FIG. 1 is a block diagram illustrating an example of a display control apparatus. A display control apparatus 100 shown in FIG. 1 is a device that displays an image to an occupant of a vehicle 1, such as a passenger car or a freight car, using an external sensor 2 mounted on the vehicle 1. The display control apparatus 100 includes an electronic control unit [ECU] 10, the external sensor 2, a GNSS receiving unit 3, a map database 4, and a human machine interface [HMI] 5. The display control apparatus 100 may be applied to a vehicle that can execute driving assistance control or a vehicle that can execute autonomous driving control.

### [Configuration of Display Control Apparatus]

As shown in FIG. 1, the display control apparatus 100 includes the ECU 10 managing the overall operation of the device. The ECU 10 is an electronic control unit including a central processing unit [CPU] and storage units such as a read only memory [ROM], a random access memory [RAM], and an electrically erasable programmable read-only memory [EEPROM]. In the ECU 10, for example, the CPU executes a program stored in the storage unit to implement various functions. The ECU 10 may be composed of a plurality of electronic units. The ECU 10 may be configured as a unit integrated with the external sensor 2 or may be configured as a unit separate from the external sensor 2.

The ECU 10 is connected to the external sensor 2, the GNSS receiver 3, the map database 4, and the HMI 5.

The external sensor 2 is a detection device detecting the surroundings of the vehicle 1, mounted on the vehicle 1. The external sensor 2 includes at least one of a camera and a radar sensor. The camera is an imaging device capturing an image of an area in front of the vehicle 1. The camera is provided, for example, on the rear side of a windshield of the vehicle 1 and captures the image of the area in front of the vehicle 1. The camera has a function of measuring a relative distance to an object (a pedestrian or the like) around the vehicle 1. The camera may be any camera having a distance measurement function such as a stereo camera. The camera may be a monocular camera that can perform predetermined image processing on the captured image to measure the distance to the object in the captured image. The camera transmits information of the captured image to the ECU 10.

The radar sensor is a detection device detecting the object around the vehicle 1 using radio waves (for example, millimeter waves) or light. The radar sensor transmits radio waves or light to the surroundings of the vehicle 1 and receives the radio waves or light reflected by the object to detect the object. Examples of the radar sensor include a light detection and ranging [LiDAR] sensor and a millimeter-wave radar. The radar sensor has a function of measuring the relative distance to the object (a pedestrian or the like) around the vehicle 1. The radar sensor transmits information of the detected object to the ECU 10.

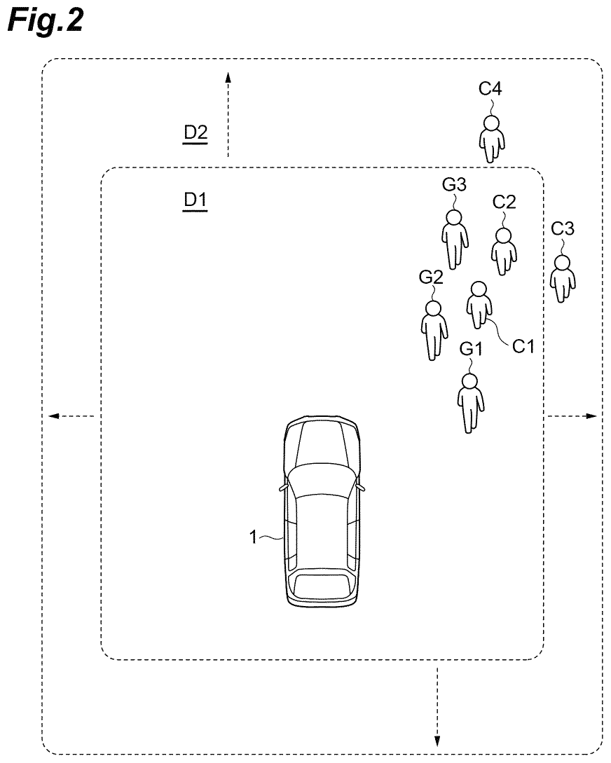

The external sensor 2 has a detection range. The detection range is a range in which the external sensor 2 can detect an object. Here, the external sensor 2 is configured, for example, to detect objects in all directions around the vehicle 1 in a plan view of the vehicle 1 (see FIG. 2 and the like).

The GNSS receiving unit 3 receives signals from positioning satellites to measure a vehicle position (for example, the latitude and longitude of the vehicle 1) which is the current position of the vehicle 1. The GNSS receiving unit 3 transmits information of the measured vehicle position to the ECU 10.

The map database 4 is a storage device storing map information. For example, the map database 4 is formed in a storage medium such as a hard disk drive [HDD] mounted on the vehicle 1. The map information may include information of a state of a shoulder of a roadway, information of a state of a sidewalk, and the like. The map database 4 may be formed in a server that can communicate with the vehicle 1.

The HMI 5 is an interface for inputting and outputting information between the display control apparatus 100 and the occupant of the vehicle 1. The HMI 5 has a display (display unit) provided in a passenger compartment of the vehicle 1. The HMI 5 outputs an image to the display in response to a control signal from the ECU 10. The display may be a multi-information display [MID] or a head-up display [HUD].

Next, a functional configuration of the ECU 10 will be described. The ECU 10 has an object recognition unit 11, a display target specification unit 12, and a display control unit 13.

The object recognition unit 11 is configured to recognize the object around the vehicle 1 based on the detection results of the external sensor 2. The object recognition unit 11 can recognize the object present within the detection range of the external sensor 2. The object recognition unit 11 may recognize the shape and type of the object based on the image captured by the camera, using a known image recognition process. The object recognition unit 11 may recognize the shape and type of the object based on object information of the radar sensor, using a known object recognition process. The object recognized by the object recognition unit 11 may be an object such as another vehicle, a pedestrian, a bicycle, or a small animal. The object recognition unit 11 may recognize, for example, the relative position, relative speed, and moving direction of the object with respect to the vehicle 1.

The display target specification unit 12 is configured to specify, as a display target object, an object present within a predetermined distance threshold around the vehicle 1, based on the object recognized by the object recognition unit 11 and the distance threshold. The display target object is an object to be displayed to the occupant of the vehicle 1. The distance threshold is a threshold for the relative distance between the vehicle 1 and the object for specifying the display target object from the objects recognized by the object recognition unit 11. The display target specification unit 12 stores, for example, the distance threshold in the storage unit of the ECU 10.

The display target specification unit 12 sets a distance threshold when a predetermined vehicle position condition or a predetermined time condition related to a predetermined object for early display is satisfied to be larger than a distance threshold when the vehicle position condition and the time condition are not satisfied. The predetermined object for early display means an object, which has been selected in advance as an object to be displayed early because it requires careful attention when approaching the vehicle 1, among the objects that may be displayed to the occupant of the vehicle 1. The predetermined object for early display may be, for example, a child when the object is a pedestrian.

The distance threshold may include a second threshold, which is a distance threshold for the predetermined object for early display to be displayed earlier than other objects, and a first threshold, which is a distance threshold for displaying the other objects using a known method. The second threshold is greater than the first threshold. The display target specification unit 12 may set the distance threshold when the vehicle position condition or the time condition is satisfied to the second threshold. The display target specification unit 12 may set the distance threshold when the vehicle position condition and the time condition are not satisfied to the first threshold.

The distance threshold is defined for the vehicle 1 by a known method. For example, the distance threshold may be defined such that a rectangular area having sides parallel to a front-rear direction and a left-right direction of the vehicle 1 is defined based on the vehicle 1. In addition, the distance threshold may be defined such that a circular area, an elliptical area, or the like is defined based on the vehicle 1. The distance threshold may be defined for each direction relative to the vehicle 1. For example, when a rectangular area is defined, the distance threshold may be defined for each of the right, left, front, and rear of the vehicle 1. For example, when a circular area, an elliptical area, or the like is defined, the distance threshold may be defined for each predetermined angle that divides a horizontal plane based on the vehicle 1 into a plurality of areas.

The predetermined vehicle position condition is a condition for early displaying the objects including the object for early display and is a condition for determining whether the vehicle position is present in an area related to the object for early display. For example, when the vehicle position is present in a predetermined child approaching area, the display target specification unit 12 determines that the vehicle position condition is satisfied based on the acquired vehicle position and map information. The child approaching area is a predetermined area on the map in which a child requiring careful attention in terms of traffic is likely to be present near the vehicle position of the vehicle 1. An example of the child approaching area is a school zone. In addition, the child approaching area may be an area in a predetermined range including locations, such as parks, residential areas, kindergartens, nursery schools, sports facilities for children, shopping malls, libraries, and pediatric clinics. For example, information of the child approaching area may be stored as the map information in the map database 4. When the vehicle position is not present in the child approaching area, the display target specification unit 12 may determine that the vehicle position condition is not satisfied.

The predetermined time condition is a condition for early displaying the objects including the object for early display and is a condition for determining whether the current time falls within a time period related to the object for early display. For example, when the current time falls within a predetermined child approaching time period, the display target specification unit 12 determines that the time condition is satisfied, based on the current time and the map information. The child approaching time period is a predetermined time period during which a child requiring careful attention in terms of traffic is likely to be present near the vehicle position of the vehicle 1. The child approaching time period may be, for example, the time when the child goes to school and the time when the child goes home from school. In addition, the child approaching time period may be, for example, the time when the child goes to or from a kindergarten, a nursery school, or a sports facility for children. For example, information of the child approaching time period may be stored as the map information in the map database 4. The display target specification unit 12 may determine that the time condition is not satisfied when the current time does not fall within the predetermined child approaching time period. The current time is not particularly limited, and the display target specification unit 12 can acquire the current time based on, for example, the reception results of the GNSS receiving unit 3.

FIG. 2 is a diagram illustrating an example of the setting of the distance threshold. In FIG. 2, adults G1 to G3 and children C1 to C4 are present as the pedestrians around the vehicle 1 in a plan view. For example, the vehicle 1 is traveling on a roadway, and the adults G1 to G3 and the children C1 to C4 are present on a sidewalk. The adults G1 to G3 and the children C1 to C4 are present within the detection range of the external sensor 2 mounted on the vehicle 1.

In a situation shown in FIG. 2, when neither the vehicle position condition nor the time condition is satisfied, the distance threshold is set to the first threshold. An area D1 in FIG. 2 indicates a rectangular range in which an object is specified as the display target object when the distance threshold is set to the first threshold. When the vehicle position condition or the time condition is satisfied, the distance threshold is set to the second threshold. An area D2 in FIG. 2 indicates a rectangular range in which an object is specified as the display target object when the distance threshold is set to the second threshold greater than the first threshold. As described above, the range in which an object is specified as the display target object is expanded from the area D1 to the area D2. Therefore, the children C3 and C4, who are not included in the area D1, but are included in the area D2, become the objects to be displayed earlier even when the vehicle position of the vehicle 1 is the same. As a result, the children C3 and C4 can be displayed early.

The object recognition unit 11 may recognize an obstacle hindering the movement of the object around the vehicle 1 based on the detection results of the external sensor 2. The display target specification unit 12 may not increase the distance threshold when the vehicle position condition or the time condition is satisfied in the direction in which the obstacle is present. The obstacle hindering the movement of the object around the vehicle 1 means an obstacle that is present between the vehicle 1 and the object and has a shape and size hindering the approach of the object to the vehicle 1. Examples of the obstacle hindering the movement of the object around the vehicle 1 include guardrails, hedges, and fences.

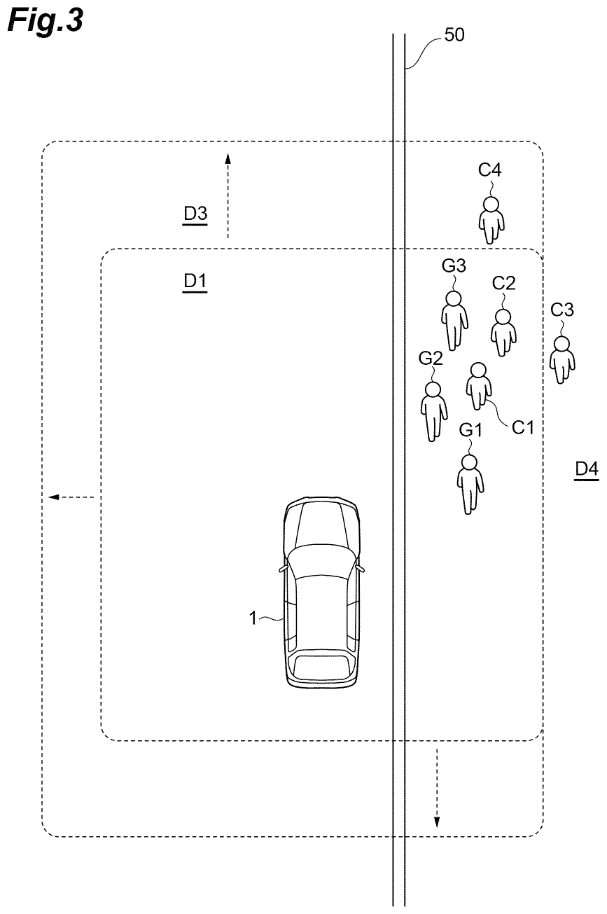

FIG. 3 is a view illustrating another example of the setting of the distance threshold. A situation shown in FIG. 3 is different from the situation shown in FIG. 2 in that a guardrail 50 is present between the roadway and the sidewalk. For example, in FIG. 3, the object recognition unit 11 recognizes the guardrail 50 as the obstacle hindering the movement of the adults G1 to G3 and the children C1 to C4 based on the detection results of the external sensor 2. For example, in FIG. 3, the display target specification unit 12 does not increase the distance threshold on the right side of the vehicle 1, which is the direction in which the obstacle is present, even if the vehicle position condition or the time condition is satisfied. Therefore, on the right side of the vehicle 1, an edge of the area D1 and an edge of the area D3 overlap each other, and the child C3 is present in an area D4 outside the area D3. As a result, the display target specification unit 12 does not specify the child C3 as the display target object, and the child C3 is not displayed early. As described above, when the guardrail 50 is present as the obstacle hindering the movement of the child C3, the degree of attention required for the child C3 is reduced. Therefore, the early display of the child C3 is suppressed, which makes it possible to prevent the display from being too complicated.

In addition, the display target specification unit 12 may store and set the distance threshold for each type of object. The display target specification unit 12 may increase the distance threshold when the vehicle position condition or the time condition is satisfied for each type of object. The display target specification unit 12 may store and set the distance threshold independently for each type of object, such as a child, an animal, or a two-wheeled vehicle.

The display control unit 13 is configured to display the display target object specified by the display target specification unit 12 on the display of the HMI 5. For example, the display control unit 13 displays the specified display target object on the display of the HMI 5 so as to correspond to each coordinate of the display target object in a three-dimensional space around the vehicle 1, using a known display method.

### [Process of Display Control Apparatus]

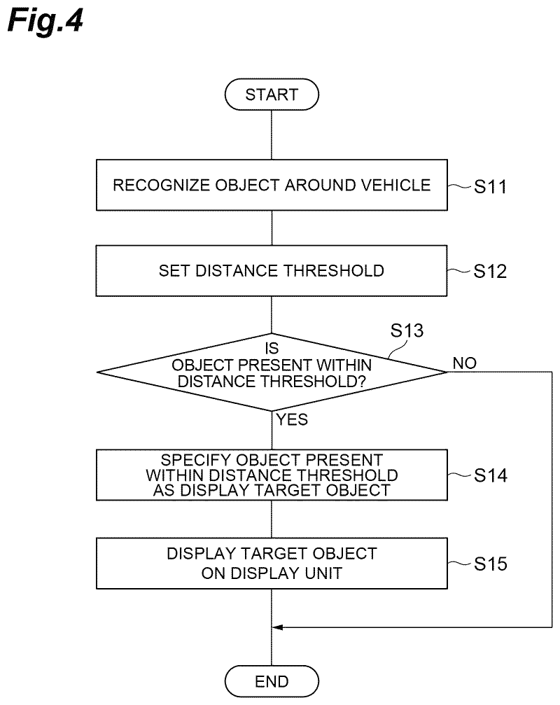

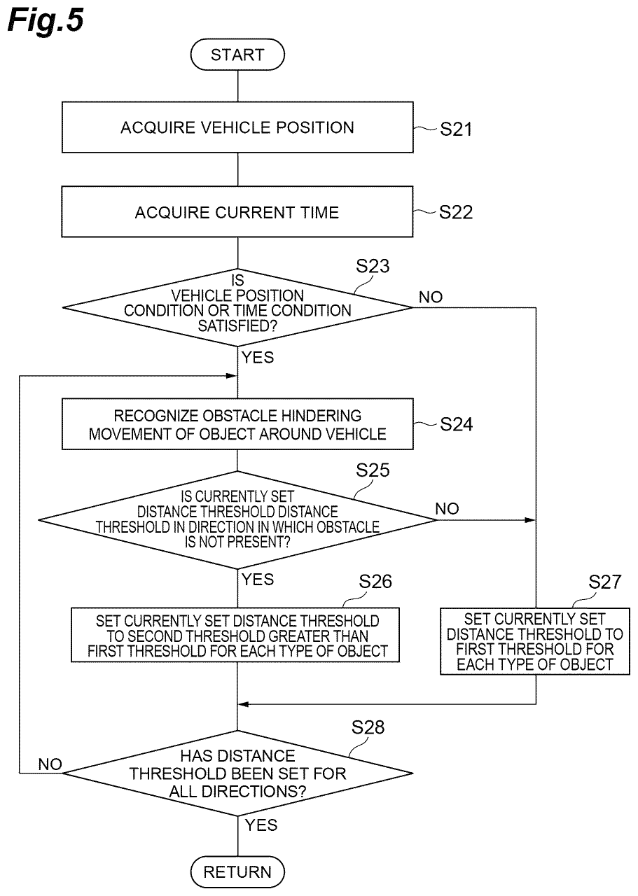

Next, an example of the process of the display control apparatus 100 will be described with reference to flowcharts shown in FIGS. 4 and 5. FIG. 4 is a flowchart illustrating an example of an object display process. The process (steps) shown in FIG. 4 is repeatedly executed with a predetermined operation period, for example, when the ECU 10 is turned on.

As shown in FIG. 4, in S11, the ECU 10 of the display control apparatus 100 recognizes the objects around the vehicle 1 using the object recognition unit 11. In FIGS. 2 and 3, the object recognition unit 11 recognizes the adults G1 to G3 and the children C1 to C4 present in the detection range of the external sensor 2 based on the detection results of the external sensor 2.

In S12, the ECU 10 sets the distance threshold using the display target specification unit 12. For example, the display target specification unit 12 sets the distance threshold according to the type of object based on the vehicle position and the current time as shown in FIG. 5.

FIG. 5 is a flowchart illustrating an example of a threshold setting process. For example, the process (steps) shown in FIG. 5 is repeatedly executed with a predetermined operation period when the ECU 10 is turned on.

As shown in FIG. 5, in S21, the ECU 10 of the display control apparatus 100 acquires the vehicle position using the display target specification unit 12. For example, the display target specification unit 12 acquires the vehicle position of the vehicle 1 based on the reception results of the GNSS receiving unit 3.

In S22, the ECU 10 acquires the current time using the display target specification unit 12. For example, the display target specification unit 12 acquires the current time at the vehicle position of the vehicle 1 based on the reception results of the GNSS receiving unit 3.

In S23, the ECU 10 determines whether or not the vehicle position condition or the time condition is satisfied using the display target specification unit 12. For example, when the vehicle position is present in the predetermined child approaching area, the display target specification unit 12 determines that the vehicle position condition is satisfied based on the acquired vehicle position and map information. When the vehicle position is not present in the predetermined child approaching area, the display target specification unit 12 may determine that the vehicle position condition is not satisfied.

For example, when the current time falls within the predetermined child approaching time period, the display target specification unit 12 determines that the time condition is satisfied based on the acquired current time and map information. When the current time does not fall within the predetermined child approaching time period, the display target specification unit 12 may determine that the time condition is not satisfied.

When the display target specification unit 12 determines that the vehicle position condition or the time condition is satisfied (S23: YES), the ECU 10 proceeds to a process in S24. When the display target specification unit 12 determines that the vehicle position condition or the time condition is not satisfied (S23: NO), the ECU 10 proceeds to a process in S27.

In S24, the ECU 10 recognizes the obstacle hindering the movement of the objects around the vehicle 1 using the object recognition unit 11. For example, in FIG. 2, the object recognition unit 11 does not recognize the obstacle hindering the movement of the adults G1 to G3 and the children C1 to C4 based on the detection results of the external sensor 2. For example, in FIG. 3, the object recognition unit 11 recognizes the guardrail 50 as the obstacle hindering the movement of the adults G1 to G3 and the children C1 to C4 based on the detection results of the external sensor 2.

In S25, the ECU 10 determines whether or not the currently set distance threshold is a distance threshold in a direction in which no obstacles are present, using the display target specification unit 12. For example, in FIG. 2, the display target specification unit 12 determines that the currently set distance threshold is the distance threshold in the direction in which no obstacles are present (YES). For example, in FIG. 3, when the distance threshold is currently being set in a direction (front, rear, or left side) other than the right side of the vehicle 1, the display target specification unit 12 determines that the currently set distance threshold is the distance threshold in the direction in which no obstacles are present (YES). For example, in FIG. 3, when the distance threshold on the right side of the vehicle 1 is currently being set, the display target specification unit 12 determines that the currently set distance threshold is not the distance threshold in the direction in which no obstacles are present (NO).

When the display target specification unit 12 determines that the currently set distance threshold is the distance threshold in the direction in which no obstacles are present (S25: YES), the ECU 10 proceeds to a process in S26. When the display target specification unit 12 determines that the currently set distance threshold is not the distance threshold in the direction in which no obstacles are present (S25: NO), the ECU 10 proceeds to the process in S27.

In S26, the ECU 10 sets the currently set distance threshold to the second threshold greater than the first threshold for each type of object, using the display target specification unit 12. For example, in FIG. 2, the display target specification unit 12 sets the distance threshold for the objects including the children C1 to C4 to the second threshold greater than the first threshold. For example, in FIG. 3, the display target specification unit 12 sets the distance threshold for the objects including the children C1 to C4 in the directions (front, rear, or left side) other than the right side of the vehicle 1 to the second threshold, which is greater than the first threshold.

On the other hand, in S27, the ECU 10 sets the currently being set distance threshold to the first threshold for each type of object, using the display target specification unit 12. For example, in FIG. 3, the display target specification unit 12 sets the distance threshold for the objects including the children C1 to C4 on the right side of the vehicle 1 to the first threshold.

In S28, the ECU 10 determines whether or not the distance thresholds for all directions have been set using the display target specification unit 12. For example, when all of the distance thresholds for the front, rear, right, and left sides of the vehicle 1 have been set, the display target specification unit 12 determines that the distance thresholds have been set for all directions. When at least one of the distance thresholds for the front, rear, right, and left sides of the vehicle 1 has not yet been set, the display target specification unit 12 determines that the distance thresholds have not been set for all directions.

When the display target specification unit 12 determines that the distance thresholds have been set for all directions (S28: YES), the ECU 10 ends the process shown in FIG. 5 and proceeds to a process in S13 shown in FIG. 4. When the display target specification unit 12 determines that the distance thresholds have not been set for all directions (S28: NO), the ECU 10 proceeds to the process in S24 and sets the distance threshold for the unset directions.

Returning to the process in FIG. 4, in S13, the ECU 10 determines whether or not an object is present within the distance threshold using the display target specification unit 12. For example, the display target specification unit 12 calculates the relative distances of the adults G1 to G3 and the children C1 to C4 from the vehicle 1 based on the detection results of the external sensor 2. When at least one of the relative distances of the adults G1 to G3 and the children C1 to C4 is equal to or less than the distance threshold, the display target specification unit 12 may determine that an object is present within the distance threshold. When all of the relative distances of the adults G1 to G3 and the children C1 to C4 are greater than the distance threshold, the display target specification unit 12 may determine that no objects are present within the distance threshold.

When the display target specification unit 12 determines that an object is present within the distance threshold (S13: YES), the ECU 10 proceeds to a process in S14. When the display target specification unit 12 determines that no objects are present within the distance threshold (S13: NO), the ECU 10 ends the process shown in FIG. 4.

In S14, the ECU 10 specifies the object present within the distance threshold as the display target object, using the display target specification unit 12. In the examples shown in FIGS. 2 and 3, when the vehicle position condition and the time condition are not satisfied, the display target specification unit 12 specifies, as the display target objects, the adults G1 to G3 and the children C1 and C2 present in the area D1 within the first threshold in all directions of the front, rear, right, and left sides of the vehicle 1. In the example shown in FIG. 2, when the vehicle position condition or the time condition is satisfied, the display target specification unit 12 specifies, as the display target objects, the adults G1 to G3 and the children C1 to C4 present in the areas D1 and D2 within the second threshold in all directions of the front, rear, right, and left sides of the vehicle 1.

In the example shown in FIG. 3, when the vehicle position condition or the time condition is satisfied and the guardrail 50 is recognized as the obstacle, the display target specification unit 12 specifies, as the display target objects, the adults G1 to G3 and the children C1, C2, and C4 that are objects present in the areas D1 and D3 within the second threshold on the front, rear, and left sides of the vehicle 1 and within the first threshold on the right side of the vehicle 1. In the example shown in FIG. 3, the display target specification unit 12 may not specify the child C3 that is an object present in the area D4 exceeding the first threshold on the right side of the vehicle 1.

In S15, the ECU 10 displays the display target object on the display of the HMI 5 using the display control unit 13. The display control unit 13 may display the specified display target object and the vehicle 1 in a plan view or a bird's-eye view or the like on the display of the HMI 5 to notify the occupant of the presence of the display target object. Then, the ECU 10 ends the process shown in FIG. 4. In the display control apparatus 100 described above, the distance threshold (second threshold) when the vehicle position condition or the time condition is satisfied is greater than the distance threshold (first threshold) when the vehicle position condition and the time condition are not satisfied. Since the pedestrians including children that are the objects for early display are likely to be present within the increased distance threshold, the pedestrians including children, that are likely to suddenly run out into the roadway, are likely to be specified early as the display target objects. Therefore, for example, the objects are not uniformly displayed early under all conditions, but the objects for early display that require early attention can be displayed early on the display of the HMI 5 only when the vehicle position condition or the time condition is satisfied. In addition, instead of just displaying an area indicating a school zone when the vehicle is present near a school as in the related art, it is possible to display children that are the actual objects of attention.

In the display control apparatus 100, the display target specification unit 12 may set the distance threshold according to the type of object and increase the distance threshold when the vehicle position condition or the time condition is satisfied for each type of object. In this case, the objects for early display that require early attention can be displayed early on the display of the HMI 5 for each type of object.

In the display control apparatus 100, the object recognition unit 11 recognizes the guardrail 50 hindering the movement of the pedestrians around the vehicle 1 based on the detection results of the external sensor 2, and the display target specification unit 12 does not increase the distance threshold in the direction in which the guardrail 50 is present, even if the vehicle position condition or the time condition is satisfied. Therefore, the child C3, whose movement is hindered by the guardrail 50, can be essentially excluded from the objects that are likely to be early specified as the display target objects.

The object for early display is a child among pedestrian, and the vehicle position condition is satisfied when the vehicle position of the vehicle 1 is included in the school zone. Therefore, it is possible to early display the child among the pedestrians as the object for early display, based on the vehicle position. In addition, since the time condition is satisfied when the current time is included in a predetermined school commute time period, it is possible to early display the child among the pedestrians as the object for early display, based on the current time.

The example of the present disclosure has been described above. However, the present disclosure is not limited to the above-described example.

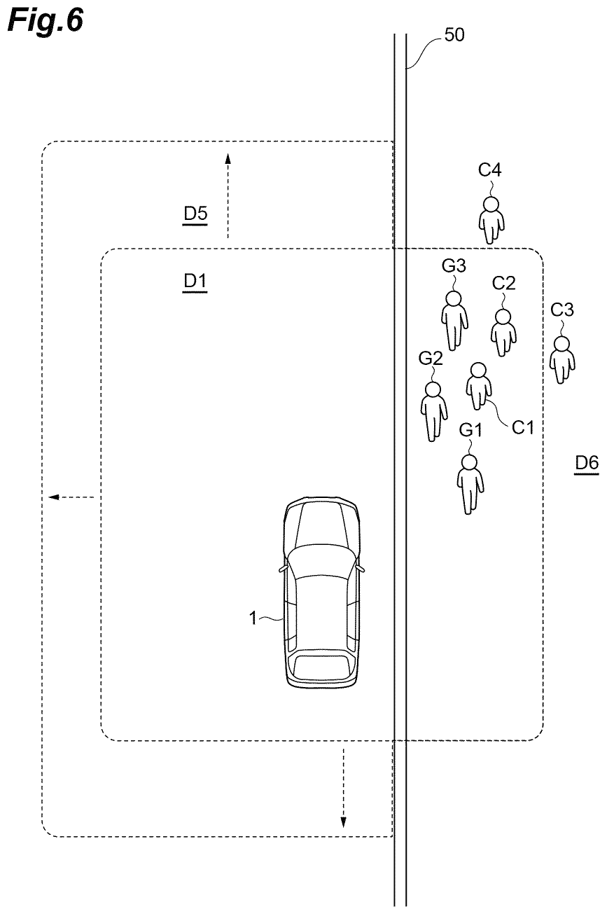

In the above-described example, in the example shown in FIG. 3, the display target specification unit 12 does not specify only the child C3, that is an object present in the area exceeding the first threshold on the right side of the vehicle 1, as the display target object. However, the present disclosure is not limited to this example. For example, as shown in FIG. 6, the display target specification unit 12 may set, to the first threshold, a portion beyond the guardrail 50 among the distance thresholds on the front and rear sides of the vehicle 1. In this case, when the vehicle position condition or the time condition is satisfied and the guardrail 50 is recognized as the obstacle, the display target specification unit 12 may specify, as the display target objects, the adults G1 to G3 and the children C1 and C2 present in the areas D1 and D5 that are within the second threshold on the front, rear, and left sides of the vehicle 1 and within the first threshold on the front, rear, and right sides of the vehicle 1, and may not specify, as the display target objects, the children C3 and C4 that are objects present in the area D6 exceeding the first threshold not only on the right side of the vehicle 1 but also on the front and rear sides of the vehicle 1. In other words, the direction in which the obstacle is present may include not only the right side but also the front and rear sides.

In the above-described example, in the direction in which the obstacle is present, the display target specification unit 12 does not increase the distance threshold even if the vehicle position condition or the time condition is satisfied, but uses the normal first threshold. However, the present disclosure is not limited to this example. When the vehicle position condition or the time condition is satisfied, the display target specification unit 12 may increase the distance threshold in the direction in which the obstacle is present by an increment smaller than the increment of the distance threshold in the direction in which no obstacles are present.

In the above-described example, the display target specification unit 12 sets the distance threshold for each type of object. However, the present disclosure is not limited to this example. The display target specification unit 12 may set the distance threshold regardless of the type of object.

In the above-described example, the object for early display is a child among pedestrians, and the display target specification unit 12 determines that the vehicle position condition is satisfied when the acquired vehicle position is present in the predetermined child approaching area. However, the present disclosure is not limited to this example. For example, the object for early display may be an animal, such as a deer, among moving objects. In this case, when the acquired vehicle position is present in a predetermined animal approaching area (for example, a mountain road or an expressway), the display target specification unit 12 may determine that the vehicle position condition is satisfied, increase the distance threshold, and early specify an animal, such as a deer, among the moving objects as the display target object. Further, the object for early display may be a two-wheeled vehicle among the moving objects. In this case, when the acquired vehicle position is present in a predetermined two-wheeled vehicle approaching area (for example, an accident-prone area based on information in an accident database), the display target specification unit 12 may determine that the vehicle position condition is satisfied, increase the distance threshold, and early specify the two-wheeled vehicle among the moving objects as the display target object.

In the above-described example, the information of the child approaching area and the information of the child approaching time period are stored as the map information in the map database 4. However, for example, the information may be stored in advance in a storage unit such as an EEPROM of the ECU 10. In this case, the map database 4 is not essential.

In the above-described example, the guardrail 50 is given as a specific example of the obstacle. However, for example, a glass exterior wall on the first floor of a building (when there is a facility, such as a showroom, beyond the glass) can also be applied as an example of the obstacle.

What is claimed is:

1. A display control apparatus comprising:
an object recognition unit configured to recognize an object around a vehicle based on a detection result of an external sensor mounted on the vehicle;
a display target specification unit configured to specify the object present within a predetermined distance threshold around the vehicle as a display target object; and
a display control unit configured to display the display target object on a display unit,
wherein the display target specification unit sets the distance threshold when a predetermined vehicle position condition or a predetermined time condition related to a predetermined object for early display is satisfied to be greater than the distance threshold when the vehicle position condition and the time condition are not satisfied.

2. The display control apparatus according to claim 1,
wherein the display target specification unit sets the distance threshold according to a type of the object and increases the distance threshold when the vehicle position condition or the time condition is satisfied for each type of the object.

3. The display control apparatus according to claim 1,
wherein the object recognition unit recognizes an obstacle hindering a movement of the object around the vehicle based on the detection result of the external sensor, and
the display target specification unit does not increase the distance threshold in a direction in which the obstacle is present, even if the vehicle position condition or the time condition is satisfied.

4. The display control apparatus according to claim 1,
wherein the object for early display is a child among pedestrians, and
the vehicle position condition is satisfied when a vehicle position of the vehicle is included in a school zone.

5. The display control apparatus according to claim 1,
wherein the object for early display is a child among pedestrians, and
the time condition is satisfied when a current time falls within a predetermined school commute time period.
